(19) United States
(12) Patent Application Publication
(10) Pub. No.: US 2007/0202867 A1
(43) Pub. Date: Aug. 30, 2007

(54) Facilitating reuse of frequencies by unlicensed cognitive devices

(76) Inventors: Alan E. Waltho, San Jose, CA (US); Jeffrey L. Schiffer, Palo Alto, CA (US); Christopher B. Rogers, Beaverton, OR (US); David G. Leeper, Scottsdale, AZ (US)

Correspondence Address: INTEL CORPORATION;c/o INTELLEVATE, LLC, P.O. BOX 52050, MINNEAPOLIS, MN, 55402, US

(21) Appl. No.: 11/361,226

(22) Filed: Feb. 24, 2006

(51) Int. Cl. H04Q 7/20

(52) U.S. Cl. 455/423

(57) ABSTRACT

A wireless device incorporates decentralized spectrum management to dynamically control a power level for each channel in a transmission spectrum. The decentralized spectrum management uses a common reference signal received from a TV station to select a channel and coordinate the transmitter power to mitigate interference. The decentralized spectrum management ensures that the propagation loss between the desired and interfering transmitters exceeds a desired power ratio in order to facilitate frequency reuse on a non-interfering basis.

Prior art radio systems may set their transmit power to a fixed power level and utilize a centralized spectrum management system to achieve a maximum link throughput on an error free basis. This centralized spectrum management approach performs the required calculations that include propagation losses between transmitters and receivers. However, the propagation losses are time varying and allowance must be made for propagation uncertainties. The higher transmit power levels that result from using the centralized spectrum management approach require a greater spatial separation before frequency reuse is possible. Therefore, this static and centralized approach of setting transmit power is inefficient in terms of spatial frequency reuse.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device that incorporates circuitry and algorithms to differentiate licensed/unlicensed devices within a given radio channel and also to monitor and analyze adjacent radio channels in accordance with the present invention;

FIG. 2 is a block diagram that illustrates wireless devices receiving and using a TV channel in accordance with the present invention; and

FIG. 3 is a flow diagram that illustrates a method of determining an occupied TV channel, characterizing adjacent reusable radio channels and setting transmit power for channel of a wireless device in accordance with the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

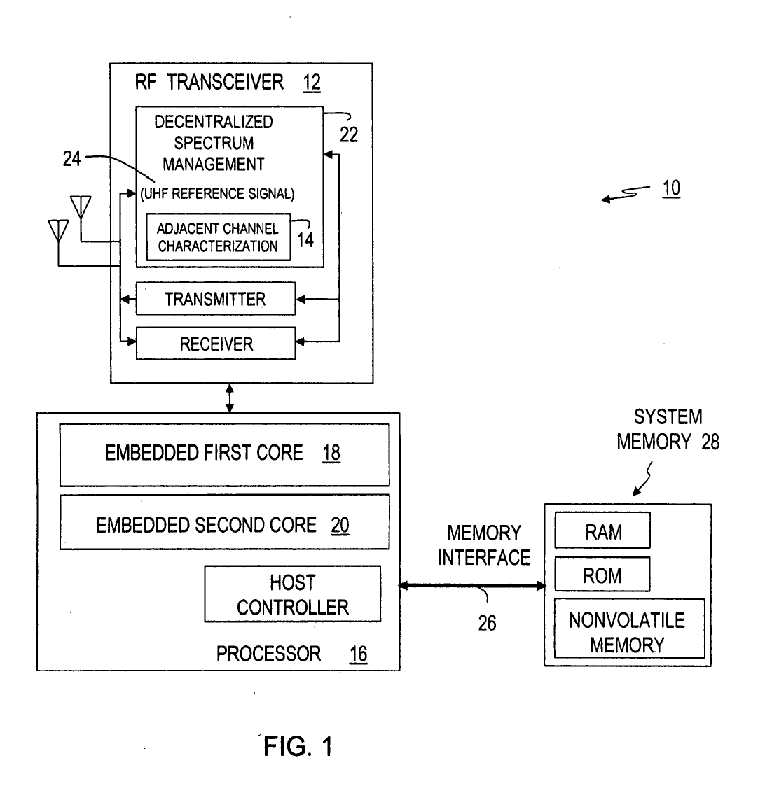

As shown in FIG. 1, wireless communications device 10 includes a radio to allow communication in an RF/location space with other devices. Accordingly, communications device 10 may operate in a wireless network such as, for example, a Wireless Local Area Network (WLAN), a Wireless Personal Area Network (WPAN), a Piconet or a combination thereof. Communications device 10 is any type of wireless device capable of communicating in an RF/location space with another device where interference may affect the quality of service of nearby radios.

The figure illustrates a transceiver 12 that both receives and transmits a modulated signal from one or more omni directional antenna. The antenna may comprise a number of types including a Planar Inverted F Antenna (PIFA), dipole antenna, monopole antenna, slot antenna, among others. Analog front end transceiver 12 may be a stand-alone Radio Frequency (RF) discrete or integrated analog circuit, or alternatively, be embedded with a processor 16 as a mixed-mode integrated circuit. The received modulated signal may be frequency down-converted, filtered, and then converted to a baseband, digital signal.

Processor 16 may include baseband and applications processing functions and utilize one or more processor cores. Processor 16, in general, processes functions that fetch instructions, generate decodes, find operands, and perform appropriate actions, then stores results. The use of multiple cores 18 and 20 may allow one core to be dedicated to handle application specific functions and allow processing workloads to be shared across the cores. Processor 16 may transfer data through interface 26 to a system memory 28 that may include a combination of memories such as a Random Access Memory (RAM), a Read Only Memory (ROM) and a nonvolatile memory, although neither the type nor variety of memories included in system memory 28 is a limitation of the present invention.

Wireless communications device 10 may operate in a network where data signal transmissions from Unlicensed Communications Devices (UCDs) and licensed commercial broadcast transmitters may operate at the same frequency. In accordance with the present invention, wireless communications device 10 may employ functional logic and various methods that allow an unlicensed device the use of a licensed broadcast spectrum on a non-interfering basis to the licensed users. To allow licensed and unlicensed devices to operate on a non-interfering basis within the same frequency band, wireless device 10 incorporates techniques and methods to identify channels unused by the licensed services and to mitigate unsuppressed, spurious emissions by unlicensed devices that would cause interference on channels adjacent to the unused channel.

A channel characterization block 14 illustrated in FIG. 1 may be used to monitor the received signal power in a communications channel and in both channels adjacent to the selected channel. Characterization block 14 may cognitively monitor the signal power in the adjacent channels in order to set the transmit power for that selected channel. Thus, the selection of the transmit power for any channel may be based on the monitored power in either of the two adjacent channels.

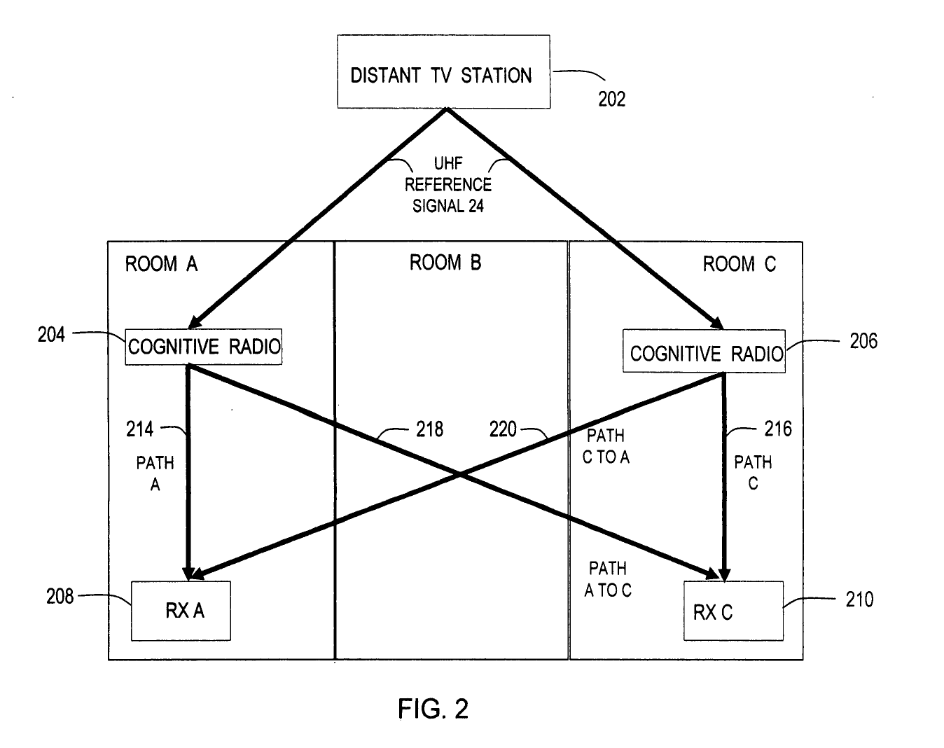

FIG. 2 illustrates receivers and transmitters operating in several rooms as an example of devices in communication that may effectively use features of the present invention. Wireless devices 204 and 208 may operate in room “A” and wireless devices 206 and 210 may operate in room “C”. If the users of these wireless devices are not aware of each other, then these devices may generate overlapping signal footprints consisting of both intentional and spurious emissions and cause mutual interference to each other.

As shown in the figure, wireless devices 204, 206, 208 and 210 provide an example of potentially interfering devices that illustrate the procedures, algorithms, and processes that cognitive wireless devices may use to communicate in a shared spectrum environment. The embodiment illustrates a TV station 202 that broadcasts in the TV spectrum on a channel. The embodiment further illustrates the cognitive wireless devices selecting for use a vacant channel not occupied by the TV broadcast but adjacent to the channel on TV station 202. Thus, cognitive wireless devices 204, 206, 208 and 210 select a vacant channel adjacent to an occupied broadcast channel. Thus, wireless devices 204, 206, 208 and 210 use an independent reference signal marked “UHF REFERENCE SIGNAL 24” in the diagram of FIG. 1 that is common to all local users for setting the transmitter power levels that allow better spectrum reuse at small spatial separations on a non interfering basis.

The various exemplary embodiments described herein are generally described in connection with “UHF REFERENCE SIGNAL 24” being the underlying technology to supply a reference signal. However, it should be recognized that the examples provided herein, and the references to Television (TV) service and the UHF band are provided to facilitate an understanding of the invention. As will be apparent to those skilled in the art from the description provided herein that embodiments of the present invention are equally applicable to other technologies, including any application where an unlicensed short range device is occupying a licensed RF broadcast channel. According, the Very High Frequency (VHF) low and high bands, Ultra High Frequency (UHF) bands, Frequency Modulation (FM) bands, Amplitude Modulation (AM) bands with existing TV, Digital Audio Broadcasting (DAB), Digital Multimedia Broadcasting (DMB), Digital Video Broadcasting (DVB), Satellite Radio, MediaFlo™, among other services, are applicable. WiMax transmitters operating in the multi-GHz range may take the place of the UHF television transmitter and UWB transceivers may choose their operating frequencies using the distant WiMax transmitter signal as a reference.

The low power transceivers of the wireless devices operate in relative close proximity, and therefore, the transceivers virtually receive the same signal from the distant TV station. In other words, the channel conditions with multiple propagation paths may provide faded signal strengths, but in this case where wireless devices are in relative close proximity the propagation loss between the transmitter of TV station 202 and the receivers in the wireless devices is substantially the same. By way of example, TV station 202 may broadcast on a channel and the wireless devices 204, 206, 208 and 210 may each receive the channel signal from the distant TV station within an approximately 3 dB level or less.

FIG. 2 further illustrates an example where frequency reuse is possible and a condition where frequency reuse is not possible. The wireless devices 204, 206, 208 and 210 in the figure have different path losses based on physical location. For instance, the path loss difference between wireless devices 204 and 208 is, in general, essentially the free space path loss over the distance “A” in path 214 that separates these two wireless devices. Similarly, the path loss in path 216 is also essentially a free space path loss over the distance “C” that separates wireless device 206 from wireless device 210.

However, the path loss in paths 218 and 220 includes a free space path loss greater than the path loss in paths 214 and 216 based on distance and further based on losses as the signal passes through the walls. The path loss from the two walls that separate room “A” from room “C” may have a value, for example, of about 2*6 dB, or 12 dB. Considering the path loss in path 218, that path loss is the sum of a free space path loss and the path loss through the two walls shown in the figure. The wireless devices 204 and 206 use reference signal 24 to adjust their own transmitter power at a level “XdB” above the reference signal, where the value of “XdB” is determined by the local regulatory requirements. The power level of the transmitters of wireless devices 204 and 206 is controlled within a few dB of each other. The difference in path losses between paths 216 and 218, and similarly the path losses between paths 214 and 220, may be measured.

The condition for interference free operation is that the path loss in path 218 exceeds the path loss in path 216 by the difference in transmitter levels plus signal (S) to noise (N) plus interference (I) ratio as S/(N+I) required for proper operation over path 216. The resultant path loss in path 218 may, for example, have a value of approximately 40 db while the path loss in path 216 may have a value of approximately 18 dB. Thus, the resultant path loss in path 218 exceeds the path loss in path 216 by approximately 22 dB. If the S/(N+I) as required for proper operation has a value of 15 dB and the difference in transmitter power levels is 3 dB, then the required difference is 18 dB. The measured difference of 22 dB (40 dB−18 dB=22 dB) allows interference free operation and frequency reuse for wireless devices operating between room “A” and room “C” may be possible in the example noted.

On the other hand, for cognitive radio 204 operating in room “A” and a receiver operating in room “B” the path loss in path 218 may be about 30 dB, for example. A path loss difference of 12 dB (30 dB−18 dB=12 dB) is below the Signal-to-Noise Ratio (SNR) required for proper operation, and therefore, interference free operation is not possible in this case. Note that for a wireless device operating in room “B” that the path loss based on distance and a one wall loss is approximately 9.5 dB, and frequency reuse is not possible for devices operating in adjacent rooms. Thus, in an apartment building frequency reuse on a non-interfering basis may be possible in any two apartments separated by at least one apartment, but not possible in any two adjacent rooms.

Note that in the example cited above that the UHF reference signal 24 may be used by wireless devices 204 and 206 as an additional mechanism to prevent radios operating in adjacent apartments or radio cells from selecting the same channel. When TV station 202 broadcasts on channel “N”, for example, the receivers in unlicensed wireless devices 204 and 206 determine that channel “N” is occupied by the TV station. Wireless devices 204 and 206 may avoid channel “N” and increment the channel to another frequency to determine if the next channel is currently in use or not in use by the TV channel.

In this first closed loop embodiment a first cognitive radio 204 determines that channel “N” is not in use and the channel is available to transmit data to device 208. The localized characterization block 14 may determine that the requirements for the communications channel operation are satisfied by characterizing the two channels adjacent to channel “N” e.g., channels “N−1” and “N+1”. The adjacent channel with the lowest received power corresponds to the UHF REFERENCE SIGNAL 24 received from TV station 202. The UHF REFERENCE SIGNAL 24 may then be used to determine the power level used by cognitive radio 204 for transmission on channel “N”. If either of the channels N−1 or N+1 are not in use, those channels may be selected as possible reusable channels.

Cognitive radio 206 may determine that channel ‘N’ is not currently in use for a TV broadcast and that cognitive radio 204 is using the channel to transmit data. Device 206 transmits to wireless device 210 on channel “N” using a power level at a preset value below the maximum level determined by the power measured in the reference channel. Wireless device 210 receives the signal power in channel “N” from wireless devices 204 and 206. Wireless device 210 measures and compares the signal power to provide a comparison of the path losses in paths 216 and 218. Wireless device 210 therefore determines whether the path loss ratio exceeds the requirements of a preset, predetermined value and whether wireless device 206 may transmit a signal to wireless device 210 without causing interference to wireless device 208. The non-interference condition is satisfied if the power ratio exceeds the predetermined value. Should the power ratio not exceed the preset value, another channel may be selected and characterized for use.

In a second open loop embodiment a first cognitive radio 204 determines that channel “N” is not in use and may be used by the cognitive radio to transmit data to wireless device 208. The localized characterization block 14 may determine that the requirements for the communications channel operation are satisfied by characterizing the two channels adjacent to channel “N”, e.g. channels “N−1” and “N+1”. The adjacent channel with the lowest received power becomes the UHF REFERENCE SIGNAL 24 received from the TV station 202. The UHF REFERENCE SIGNAL 24 may be used to determine the power level used by cognitive radio 204 for transmission on channel “N”. If either of the channels N−1 or N+1 are not in use, those channels may be selected as possible reusable channels.

Cognitive radio 206 may determine that channel ‘N’ is not used by a TV broadcast but that cognitive radio 204 is using the channel to transmit data. Wireless device 206 measures the signal power received in the UHF reference channel and the power received in channel “N”. By knowing from the power received in the reference channel and the transmitter power used by cognitive radio 204, the cognitive radio 206 may then determine the path loss in path 218. By comparing the path loss in path 218 with the path loss allowed on path 216, cognitive radio 206 may determine whether it can transmit a signal to wireless device 210 without causing interference to wireless device 208. The allowable path loss on path 216 is P_{T} minus R_{S} dBm, where P_{T} is the power “XdB” above the power received in the reference channel and RS is the sensitivity of the receiver in wireless device 210. The non-interference condition is satisfied if the path loss ratio exceeds a value of 18 dB. Should the path loss not exceed the required value, then cognitive radio 206 selects another channel to characterize.

Thus, the decentralized spectrum management 22 incorporated into the transceiver of the wireless devices uses an independent signal reference to select a channel for use and control the effective radiated power of unlicensed transmitters. To facilitate greater usage of the frequency spectrum, decentralized spectrum management 22 takes into account a channel occupied by a TV station, the radio separation distance as related to the effective radiated power of the transmitter, the desired signal-to-noise ratio and an estimate of the propagation losses in the paths from the transmitters to the receiver.

In the provided example the power ratio for channels N, N−1 and N+1 is calculated and that ratio value compared to a predetermined channel requirement. If the power ratio requirement is met then the selected channel may be used for communications. If the power ratio requirement is not met then the next available vacant channel is characterized to determine viability against the power ratio criteria. Provided that the propagation loss between the desired and interfering transmitters exceeds the desired signal-to-noise ratio, then frequency reuse can be accomplished on a non-interfering basis.

One advantage of incorporating decentralized spectrum management 22 into transceiver 12 is that the maximum power of both the desired signal and the interfering signal may be coordinated through the use of a common reference signal 24. The common reference signal 24 at least provides a power control signal from, in this example, a distant TV station to other devices operating in the network to coordinate the power of the transmitters. Upon receiving the reference signal 24, an unlicensed device may take steps to avoid interference that include reducing transmission power in its own transmitter. This allows frequency reuse at smaller physical separations of transmitters than would be possible in systems that only use one centralized controller. The decentralized spectrum management 22 also allows frequency reuse in one way broadcast communications systems in which there is no feedback from the receiver(s).

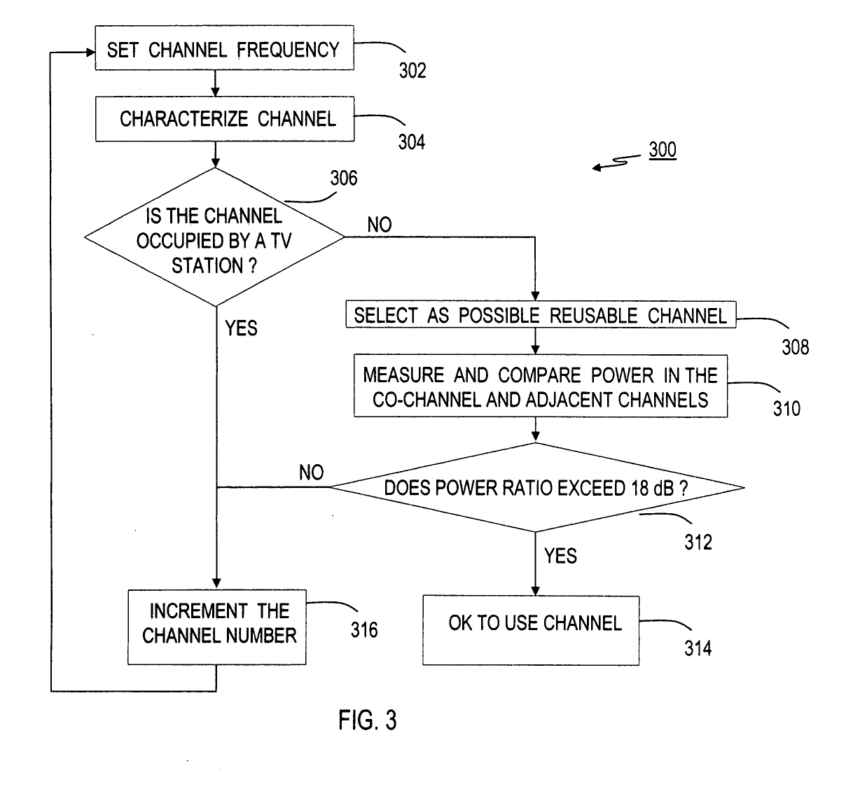

FIG. 3 shows a flowchart in accordance with various embodiments of the present invention. In some embodiments, method 300, or portions thereof, is performed in normal operation by the RF transceiver. In other embodiments, method 300, or portions thereof, may be performed by the RF transceiver in cooperation with a processor. Note that method 300 is not limited by the particular type of apparatus, software element, or system performing the method. Method 300 is shown beginning at block 302 in which RF transceiver 12 scans the channels to select a channel frequency. In block 304 the selected channel is characterized. In block 306 a determination is made as to whether the selected channel is occupied by a TV station. If the channel is occupied, then in block 316 the channel number is incremented, then looping back to block 302 to set the channel frequency.

From block 306, if the determination is made that the selected channel is not occupied by a TV station, then in block 308 that unused channel is selected as a possible channel to reuse. In block 310 the unused, reusable channel may be measured to determine channel characteristics and the power measured and compared in the communication channel and in the adjacent channels against a predetermined power value. If the power ratio does not exceed a value of 18 dB as determined in block 312, then the channel number is incremented in block 316. If the power ratio does exceed a value of 18 dB as determined in block 312, then the channel is ready for use. Note that the various actions in method 300 may be performed in the order presented, or in some embodiments, additional actions may be included in method 300.

By now it should be apparent that cognitive radio networks that incorporate features of the present invention may operate in close proximity to each other and on the same RF channel while avoiding mutual interference to each other. A common reference signal from a TV station, for example, may be used with an adjacent channel characterization circuit to measure channel information for setting the transmit power of the co-channel and adjacent channel signals. The independent reference signal is common to all local users and may be used for setting transmitter power levels which result in better spectrum reuse at small spatial separations on a non-interfering basis.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless device, comprising:
a cognitive radio to determine that a first channel is not in use; and
a characterization block in the cognitive radio to characterize two adjacent channels where one of the adjacent channels receives a reference signal that determines a power level used by the cognitive radio to transmit on the first channel.

2. The wireless device of claim 1 wherein the reference signal is an Ultra High Frequency (UHF) signal received from a TV station.

3. The wireless device of claim 2 wherein the characterization block characterizes the two adjacent channels to select the adjacent channel with the lowest received power.

4. The wireless device of claim 3 wherein the adjacent channel with the lowest received power corresponds to the adjacent channel that receives the UHF signal.

5. A wireless device comprising:
a transceiver to monitor and find a first channel not broadcasting a Ultra High Frequency (UHF) signal; and
a characterization block to characterize the first channel and at least one adjacent channel that receives the UHF signal that is used to set a power level used by the wireless device for transmission on the first channel.

6. The wireless device of claim 5 wherein the wireless device is an unlicensed wireless device.

7. The wireless device of claim 5 wherein the characterization block calculates power ratios for the first channel and the at least one adjacent channel to compare a predetermined channel requirement.

8. A wireless device comprising:
first and second antenna coupled to a transceiver; and
a spectrum management circuit coupled to at least one of the first and second antenna to increment a channel number to locate a first channel unoccupied by a TV station.

9. The wireless device of claim 8 wherein the spectrum management circuit sets a first channel power level so that the adjacent channel receives a signal from the TV station.

10. The wireless device of claim 9 wherein the spectrum management circuit dynamically monitors and characterizes the first channel and the adjacent channel to determine signal powers.

11. The wireless device of claim 7 wherein the signal power in the adjacent channel is used to set a transmit power for the wireless device.

12. A wireless device comprising:
an antenna coupled to a transceiver; and
a spectrum management circuit coupled to the antenna to locate a licensed Radio Frequency (RF) broadcast channel that is selected as an adjacent channel to prevent the wireless device from using the adjacent channel for communications.

13. The wireless device of claim 12 wherein the licensed RF broadcast channel is a Very High Frequency (VHF) channel.

14. The wireless device of claim 12 wherein the licensed RF broadcast channel is a Ultra High Frequency (UHF) channel.

15. The wireless device of claim 12 wherein the licensed RF broadcast channel is a Frequency Modulation (FM) channel.

16. The wireless device of claim 12 wherein the licensed RF broadcast channel is an Amplitude Modulation (AM) channel.

17. The wireless device of claim 12 wherein the licensed RF broadcast channel is a WiMax channel.

18. A method of providing spectrum management in a wireless device, comprising:
investigating, in the wireless device, received channel frequencies to determine an unoccupied channel;
selecting the unoccupied channel as a reusable channel;
measuring a power in the reusable channel and a power in the channels adjacent to the reusable channel; and
comparing power in the reusable channel to a predetermined power value.

19. The method of claim 18 wherein comparing power further includes comparing the power in the reusable channel to a predetermined power value which corresponds to a Signal-to-Noise Ratio (SNR) value for proper operation of a modulation scheme.

20. The method of claim 18 wherein investigating received channel frequencies further includes setting a channel to receive Ultra High Frequency (UHF) signals generated by a TV station.

21. The method of claim 18 further comprising:
incrementing a channel number to determine the unoccupied channel.

22. A method comprising:
determining that a channel is currently unoccupied; and
using an Ultra High Frequency (UHF) signal received in an adjacent channel of a wireless device to prevent the wireless device from selecting the adjacent channel for communications.

23. The method of claim 22 wherein using a UHF signal received in an adjacent channel of a wireless device further includes using an unlicensed wireless device.

24. The method of claim 22 further including:
characterizing the channel and the adjacent channel that receive the UHF signal to determine power levels.

25. The method of claim 24 further including:
setting a power level used by the wireless device for transmission on the first channel in accordance with the power level in the adjacent channel.

26. The method of claim 25 further including:
calculating power ratios for the channel and the adjacent channel to compare with a predetermined channel requirement.
